(19) United States
(12) Patent Application Publication
(10) Pub. No.: US 2015/0327529 A1
(43) Pub. Date: Nov. 19, 2015

(54) TACKLE TRAP

(71) Applicant: Amber Zimmerman, Weatherford, OK (US)

(72) Inventor: Amber Zimmerman, Weatherford, OK (US)

(21) Appl. No.: 14/713,074

(22) Filed: May 15, 2015

Related U.S. Application Data
(60) Provisional application No. 61/993,433, filed on May 15, 2014.

(51) Int. Cl. A01K 97/06; A01K 99/00; A01K 97/00

(52) U.S. Cl. CPC A01K 97/06; A01K 97/00; A01K 99/00

(57) ABSTRACT

A device used for transporting a fishing rod where the device includes a clamp configured to engage the fishing rod and an enclosure connected to the clamp and configured to accept the end of the fishing rod and a hook. The enclosure may include a first side and second side connected together via a hinge and which may be closed together and locked via a locking mechanism.

### REFERENCE TO RELATED APPLICATIONS

This application claims the benefit of U.S. Provisional Patent Application 61/993,433, filed May 15, 2014, which is incorporated herein by reference.

### FIELD OF THE INVENTION

The present invention relates generally to the field of fishing lure and hook covers. More particularly, but not by way of limitation, to an improved device for transporting, storing and mounting rods, hooks and lures.

### BACKGROUND OF THE INVENTION

Transporting fishing rods or poles with hooks and lures left on the line can be a difficult process. Often anglers are hooked by lures or attached fishing hooks while they are transporting their fishing rod. Additionally, a hook or lure may snag on other people, objects, plants, and other environmental surroundings when the fishing rod is being transported. Hooks, lines and lures can become tangled and damaged when multiple rods are being stored or transported in the same place. Fishing rods may experience warping and damage due to bending the rod to attach a hook or lure to a lower eye of the rod for storage. Further, the end eyes of fishing rods can become damaged if not stored properly, thus forcing anglers to spend extensive amounts of money on repairs or replacements.

Conventional methods of removing a hook or lure from the fishing rod during transportation and storage are time consuming and undesirable for short trips or temporary storage. Additionally, removing the lure or hook and placing it in a tackle box does not always prevent them from being tangled with other lures and objects in the tackle box. Devices are known that relate to fish hook and lure covers. However, these devices merely cover the lure and must be separately attached to the lower shaft of a fishing rod to lock the cover in a closed position.

Accordingly, there continues to be a need for a device that allows for the safe and secure transportation of attached hooks or lures on the end of a fishing rod. It is to these and other deficiencies in the prior art that the present invention is directed.

### SUMMARY OF PREFERRED EMBODIMENTS

Presently preferred embodiments include a device for transporting a fishing rod. The device preferably includes a clamp configured to engage the fishing rod and an enclosure connected to the clamp and configured to accept the end of the fishing rod and a hook. The enclosure may include a first side and second side connected together via a hinge and which may be closed together and locked via a locking mechanism. In a preferred embodiment the clamp includes a compressible material for holding the fishing rod within an interior of the clamp. The clamp is constructed to allow the device to be snapped onto a wall-mounted rack for storage of the fishing rod when not in use.

### BRIEF DESCRIPTION OF THE DRAWINGS

FIG. 1 presents a perspective view of a tackle trap constructed in accordance with a preferred embodiment.

FIG. 2 presents a side view of the tackle trap of FIG. 1 in closed position.

FIG. 3 presents a perspective view of the tackle trap of FIG. 1 in a closed and locked position.

FIG. 4 presents a side view of the tackle trap of FIG. 1 on a fishing rod.

FIG. 5 presents a perspective view of an alternative embodiment of the tackle trap in an opened position.

FIG. 6 presents a side view of the tackle trap of FIG. 1 secured onto a wall mounted bracket.

### DETAILED DESCRIPTION OF PREFERRED EMBODIMENTS

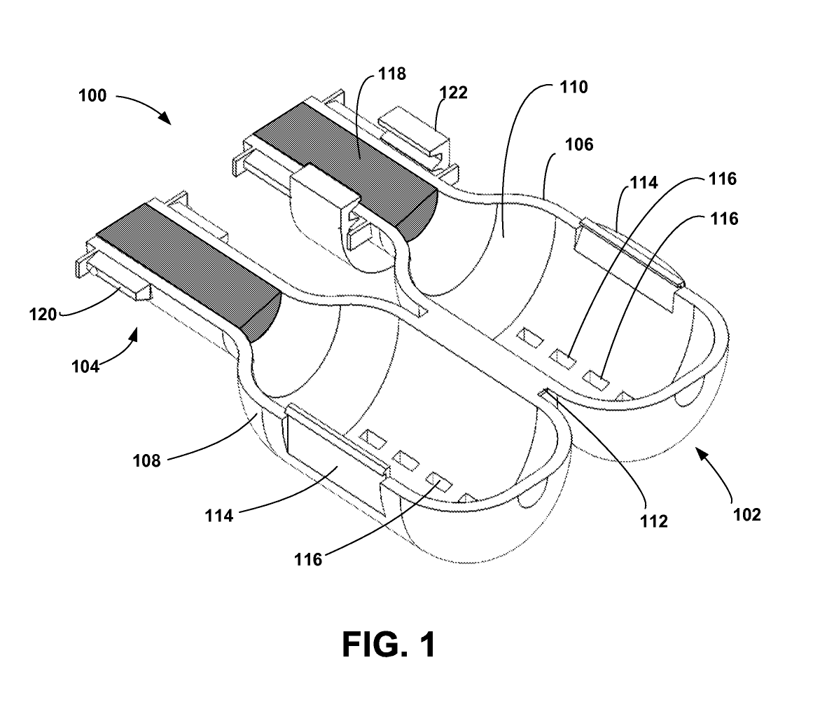

Referring to FIG. 1, shown therein is a preferred embodiment of a tackle trap 100 in an open position. The tackle trap 100 includes an enclosure 102 and a clamp 104 connected to the enclosure 102. The enclosure 102 of the tackle trap 100 may include a first side 106, a second side 108, and an interior 110. The first side 106 and the second side 108 may be connected via a hinge 112. The first side 106 and the second side 108 may be closed together via the hinge 112 and secured with a closure 114, such as a snap closure or a clip closure, to form an oval-shaped bulb.

The enclosure 102 may also contain a plurality of vents 116. It will be appreciated that the plurality of vents 116 may be located anywhere on or between the first side 106 and the second side 108 of the enclosure, and may be of various sizes and shapes.

As further depicted in FIG. 1, the clamp 104 may include a compressible material 118 within the interior 110. It will be appreciated that the compressible material 118 is preferably constructed of foam, rubber, silicone, neoprene, or the like. The clamp 104 may also include a keeper 120 and a collar 122.

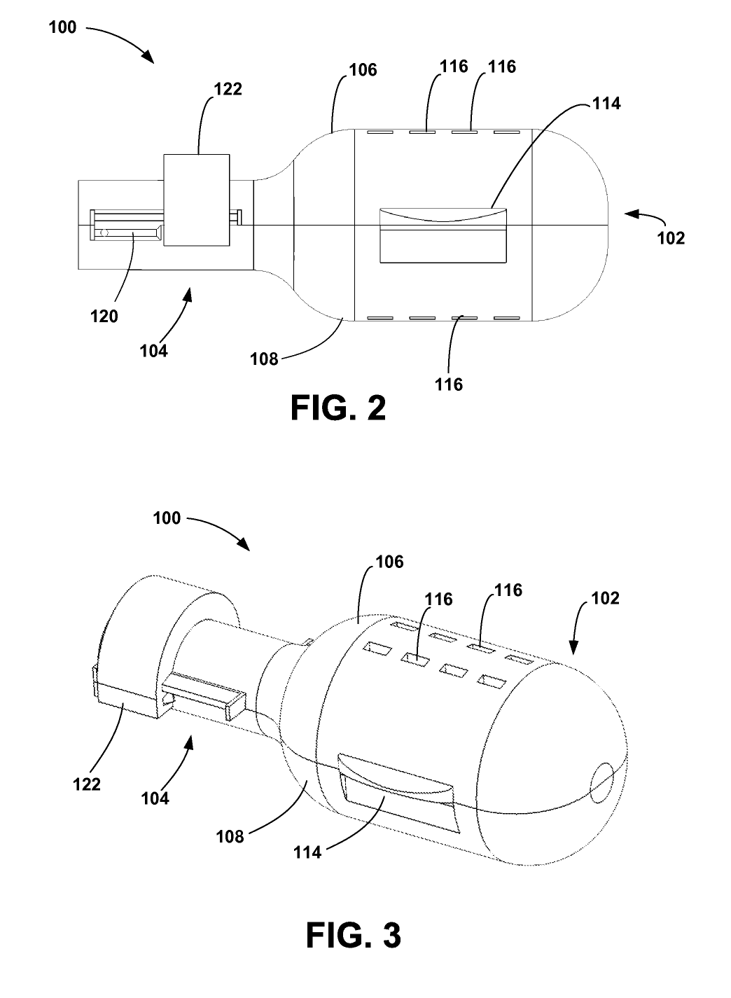

Turning to FIG. 2, the tackle trap 100 is depicted in a closed position such that the first side 106 and the second side 108 of the enclosure 102 are closed together and secured with the closure 114. In FIG. 3, the tackle trap 100 is depicted in a closed and locked position such that the clamp 104 has been further secured by sliding the collar 122 away from the enclosure 102 and over the keeper 120 to further prevent the tackle trap 100 from opening. It will be understood that the keeper 120 and the collar 122 may be used together with, or alternatively to closure 114.

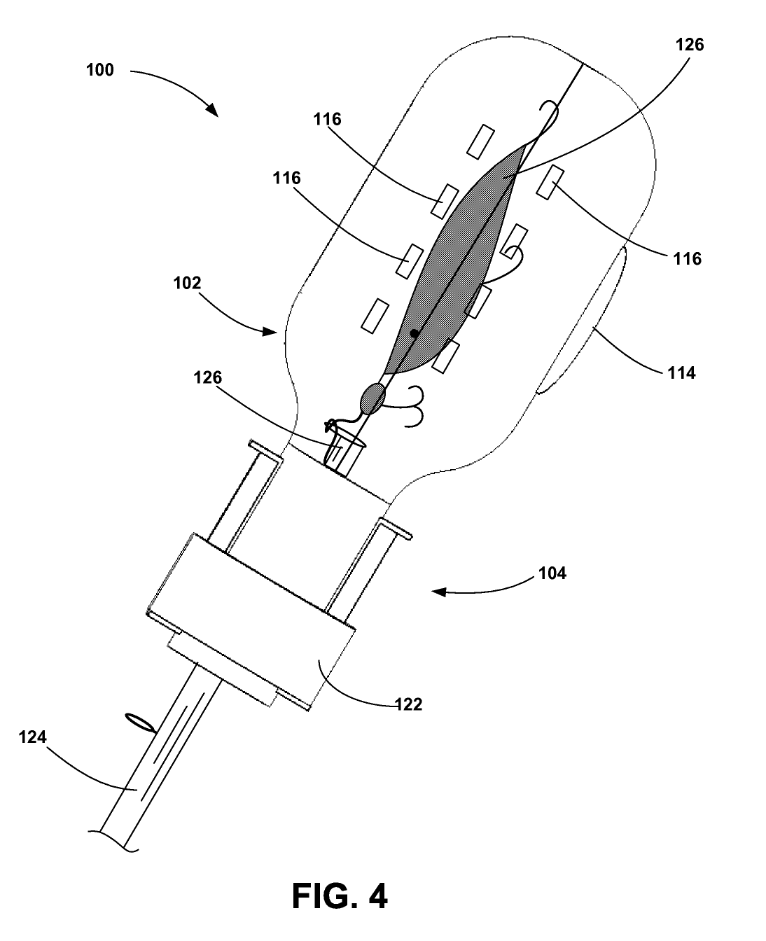

Turning now to FIG. 4, depicted therein is the tackle trap 100 shown on a fishing rod 124.

The clamp 104 engages the fishing rod 124 and the enclosure 102 holds both an end 126 of the fishing rod 124 and the lure 128, or alternatively a hook or bait. The rod 124 is secured by the clamp 104, which prevents the rod 124 from moving up and down and side to side. The clamp 104 is preferably narrower in diameter than the enclosure 102 to provide a more secure grip on the rod 124, which typically has a smaller diameter than the lure 128.

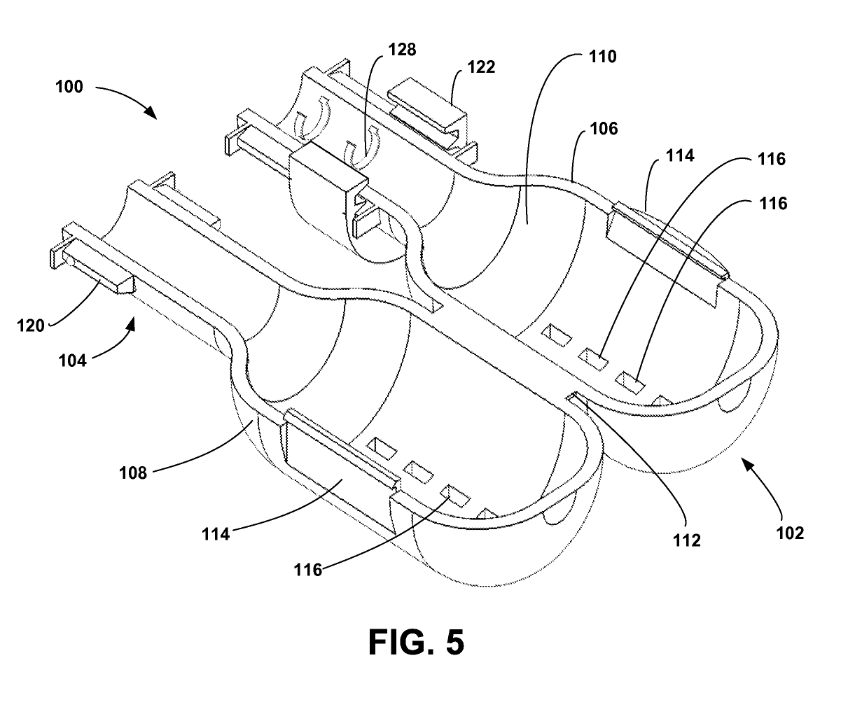

The compressible material 118 (depicted in FIG. 1) serves to protect the rod 124 during storage and transportation by maintaining the rod 124 in a secure and stable position within the clamp 104. Additionally, the compressible material 118 provides a non-slip surface to secure the tackle trap 100 onto the rod 124. It will be understood that other mechanisms may be used within the clamp 104 to keep the rod 124 from moving. These mechanisms may include any known means of securing the rod 124, such as one or more clips 128 as depicted in an alternative embodiment in FIG. 5, and may also include, but is not limited to, spring clamps, pinch clamps, pipe clamps and the like.

Enclosing the end 126 of the rod 124 and lure 128 inside of the enclosure 102 of the tackle trap 100 provides an angler with the ability to easily transport and store the rod 124 with an attached lure 128 when the rod 124 is not in use.

In the presently preferred embodiment depicted in FIG. 4, the enclosure 102 of the tackle trap 100 is constructed of a clear material to be able to clearly view the lure 128.

However, it will be understood that the tackle trap may be opaque or semi-transparent. It will also be appreciated that the tackle trap 100 is preferably constructed using durable, long-lasting materials, such as plastic or metal to provide a strong and durable structure to protect the rod 124 and/or lure 128 from being damaged during transportation or storage. Additionally, plastics or metals that incorporate rust-preventative materials may be used to prevent the rod 124, the lure 128 or hooks from rusting within the enclosure 102.

As depicted in FIGS. 1-6, the clamp 104 of the tackle trap 100 is connected as part of the same body as the enclosure 102. However, it will be understood that the clamp 104 may be separate from the enclosure 102 and may be connected to the enclosure 102 using screws, glue, clamps, fasteners or other connecting means.

In a preferred embodiment, the enclosure 102 in a closed position measures approximately three inches in length and two inches in width to accommodate a large variety of fishing lures. However, it will be understood that a variety of widths and lengths may be used depending on the sizes of the rod 124 and/or the lure 128. Further, while the tackle trap 100 is depicted as bulb-shaped, it will be appreciated that the tackle trap 100 may vary be a variety of shapes depending on the storage needs for the particular type of rod 124. By way of example, the tackle trap 100 could be rectangular or other shapes having flat sides to allow for easily stacking multiple tackle traps 100 together.

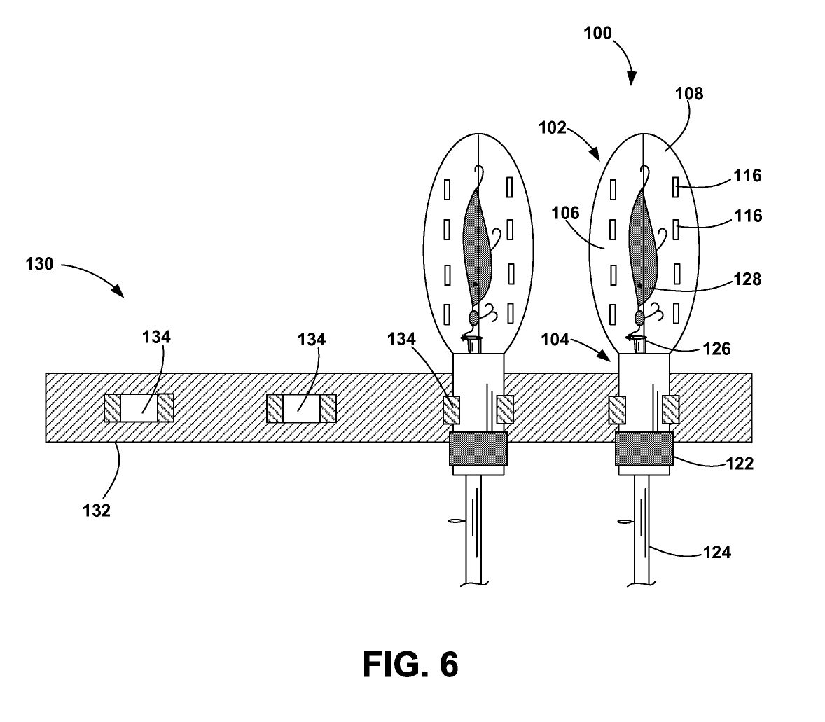

Referring now to FIG. 6, shown therein is a preferred embodiment of the tackle trap 100 secured onto a bracket 130. The bracket 130 includes a wall support 132 and a plurality of snap hooks 134. The clamp 104 easily mounts into the snap hooks 134 of the bracket 130 for storage when not being used. Hanging the rod 124 via the tackle trap 100 onto the bracket 130 prevents bending and warping of the rod 124. Additionally, use of the tackle trap 100 eliminates the need to secure the hook or lure 128 to an eye of the rod 124, which also prevents warping of the rod 124.

It is clear that the present invention is well adapted to carry out its objectives and attain the ends and advantages mentioned above as well as those inherent therein. While presently preferred embodiments of the invention have been described in varying detail for purposes of disclosure, it will be understood that numerous changes may be made which will readily suggest themselves to those skilled in the art and which are encompassed within the spirit of the invention disclosed herein and in the associated drawings and appended claims.

It is claimed:

1. A tackle trap device, the device comprising:
a clamp configured to engage a fishing rod; and
an enclosure configured to accept an end of the fishing rod and a hook, wherein the enclosure is connected to the clamp.

2. The device of claim 1, wherein the enclosure further comprises:
a first side;
a second side connected to the first side via a hinge; and
a locking mechanism, wherein the locking mechanism selectively prevents the enclosure from opening.

3. The device of claim 2, wherein the clamp further comprises a compressible material for holding the fishing rod within an interior of the clamp.

4. The device of claim 2, wherein the clamp further comprises a clip for holding the fishing rod within an interior of the clamp.

5. The device of claim 2, wherein the locking mechanism comprises a snap closure.

6. The device of claim 2, wherein the locking mechanism further comprises:
a locking collar positioned around the clamp; and
a keeper positioned on a side of the clamp;
wherein the locking collar is configured to slide over the keeper.

7. The device of claim 2, wherein the clamp is configured to allow the device to be snapped onto a wall-mounted rack for storage of the fishing rod and the hook when not in use.

8. The device of claim 3, wherein the locking mechanism comprises a snap closure.

9. The device of claim 3, wherein the locking mechanism further comprises:
a locking collar positioned around the clamp; and
a keeper positioned on a side of the clamp;
wherein the locking collar is configured to slide over the keeper.

10. The device of claim 3, wherein the clamp is configured to allow the device to be snapped onto a wall-mounted rack for storage of the fishing rod and the hook when not in use.

11. A tackle trap device, the device comprising:
a first side, wherein the first side has a first tapered end;
a second side, wherein the second side has a second tapered end;
a hinge connecting the first side to the second side, wherein closing the first side and the second side via the hinge forms an enclosure having an interior for holding an end of a fishing rod and a hook, and wherein the first tapered end and the second tapered end form a clamp for securing the fishing rod in place; and
a locking mechanism, wherein the locking mechanism selectively prevents the enclosure from opening.

12. The device of claim 11, wherein the clamp comprises a compressible material located with the interior to prevent the fishing rod from moving within the enclosure.

13. The device of claim 11, wherein the clamp comprises a clip located with the interior to prevent the fishing rod from moving within the enclosure.

14. The device of claim 11, wherein the locking mechanism comprises a snap closure.

15. The device of claim 11, wherein the locking mechanism comprises:
a locking collar located around the clamp; and
a keeper located on the first side and the second side of the clamp;
wherein the locking collar is configured to slide over the keeper.

16. The device of claim 11, wherein the clamp is formed to allow the device to be snapped onto a wall-mounted rack for storage of the fishing rod and the hook when not in use.
